(19) United States
(12) Patent Application Publication
(10) Pub. No.: US 2026/0043310 A1
(43) Pub. Date: Feb. 12, 2026

(54) DEVICE FOR REDUCING OIL VISCOSITY AND DISSOLVING INCRUSTATIONS IN PIPELINES

(71) Applicants: Welerson Romaniello De Freitas, Belo Horizonte, MG (BR); Abdias Magalhães Gomes, Belo Horizonte, MG (BR)

(72) Inventors: Welerson Romaniello DE FREITAS, Belo Horizonte (BR); Abdias Magalhães GOMES, Belo Horizonte (BR)

(21) Appl. No.: 18/838,493

(22) PCT Filed: Apr. 17, 2023
(86) PCT No.: PCT/BR2023/050120

§ 371 Date: Apr. 30, 2025

(30) Foreign Application Priority Data
Apr. 20, 2022 (BR) 2020220075692

(51) Int. Cl. E21B 37/00; B08B 7/00

(52) U.S. Cl. CPC E21B 37/00; B08B 7/00

(57) ABSTRACT

A device for reducing viscosity and dissolving incrustations in pipelines comprising a central tube comprising two ends and one or more external threads at the two ends for coupling, a conical reduction, a protective jacket, and one or more spacer rings. The central tube is fixed to an orifice of the conical reduction by one or more weld fillits. The conical reduction comprising one or more permanent magnet collars and are internal to the protective jacket, the protective jacket is fixed to the conical reduction via a hole fully penetrating the one or more weld fillits. The one or more spacer rings, without a megnetic field dress the central tube, positioned juxtaposed to the one or more permanent magnet collars so that the ends of the one or more spacer rings are fixed to the central tube to preserve the location of the one or more spacer rings.

### CROSS-REFERENCE TO RELATED APPLICATIONS

This application is a national stage entry of International application No. PCT/BR2023/050120 filed Apr. 17, 2023, which claims priority to Brazilian Patent Application No. 2020220075692 filed on Apr. 20, 2022, the entire contents of both of which are incorporated herein by reference.

### FIELD

This utility model patent is for an industrial product with applications in the oil sector and fluid networks in general, which treats fluids through magnetic activation, reducing viscosity and dissolving existing organic or inorganic incrustations.

### BACKGROUND

In the mid-1950s, VERMEIREN discovered the effects of magnetic water treatment. He presented a magnetic field of permanent magnets acting on the fouling salts in water. Later, at the beginning of the 1980s, work such as that by Kochmarsky. V. Z. and others (Khimya i Teknologya Vody Vol.4 n.3 1981 in Russian) and K. W. Busch and others (Corrosion 1984, Boston, Massachusetts) showed, using different approaches, that the magnetic field transverse to the flow velocity acts on the ions of the fouling salts, such Ca⁺⁺ and CO3⁻⁻, exerting forces in opposite directions on them, bringing them together in the form of CaCO3. These particles, formed in the volume of the fluid itself, act as a growth nucleus, preventing them from being deposited in the pipes. Completing the authors'reasoning, the magnetic field causes the calcium carbonate to precipitate in the form of Aragonite, a soft and friable allotropic variety, instead of Calcite, the latter being hard, with crystals with high coalescence power.

The magnetic activation of aqueous systems and other fluids has found application in the most varied fields of human activity, ranging from the vast majority of industrial and energy processes. Magnetic treatment has come to be used to combat fouling in systems containing fouling salts subjected to high pressures, in the enrichment of ores, in the production of concrete and mortar as well as in the acceleration of filtration and purification processes, in reducing the viscosity of oil and its derivatives and other fluids.

Most of the technical literature analyzes the effects of magnetic activation of fluids from an experimental point of view, based on the physical LORENTZ FORCE, which is the force of a transverse magnetic field on moving charged particles, reporting changes in various properties, especially viscosity, surface tension, pH, electrical conductivity, an increase in the electric dipole moment of organic and inorganic molecules, induction of electric dipole moments in apolar molecules and an increase in the propagation speed of ultrasound.

As early as 1997, studies showed that the magnetic field reduced the viscosity of crude oils, as well as reducing organic incrustations (depositions) and preventing the formation of inorganic incrustations (Marques and Rocha, Paper SPE 38990). In 2001, Nguyen Phuong and others (Paper SPE 69749) experimentally confirmed the results of Marques and Rocha's work and developed theoretical models to explain the reduction in viscosity of crude oils and the reduction of organic fouling on the walls of central tubes. With regard to the reduction of inorganic fouling, these authors repeat the well-established considerations. More recently, in 2021, Chen Jiang and others (Colloids and Surfaces: Physicochemical and Engineering Aspects 629 2021) quantitatively showed the reduction in viscosity of four varieties of crude oils with API grades ranging from 15.4o to 32.87o. The results show that viscosity can be reduced by up to 25%. These authors do not specify all the variables that led to the results presented, such as the intensity of the magnetic field, flow velocity, pressure, time the oil was exposed to the magnetic field, Reynolds number and others.

As shown above, although the state of the art presents various results on the magnetic activation of crude oils, aimed at reducing viscosity and inhibiting organic and inorganic fouling, and clear indications of the advantages of such activation, no publication specifies the optimum conditions for the magnetic activation of crude and refined oils with regard to the two groups of variables, fluid characteristics and the variables specific to magnetic activation.

In the available technical literature, the optimum conditions for magnetic activation of oils and other fluids are not specified with regard to flow velocity, flow regime, magnetic field strength, pH, salt concentration, temperature, pressure and others.

### SUMMARY

The device in question operates through the action of magnetic fields formed by permanent magnets arranged radially in a pipe. The magnetic action polarizes the fluid molecules. Designed and tested with crude oil and also in refining processes. It is also applied to fluids with solid particulates moving in the pipe. The presence of incrustations in pipes in the oil and gas industry, whether organic or inorganic, are factors that reduce the production of wells. In practical terms, these incrustations lead to a reduction in the diameter of the pipes and greater energy consumption, as well as greater wear and tear on equipment, such as submerged centrifugal pumps.

The device in question reduces the viscosity of the fluid and thus allows for greater internal velocity in the pipe, lower pressure in the pumping installation, greater flow and lower electricity consumption. With regard to viscosity, it is also a well-established fact that reducing the viscosity of a fluid leads to an increase in flow, as well as lower pressure in the pipe and consequent energy savings.

The physical action of the device is the formation of strong magnetic fields generated by multiple collars segmented by neodymium boron iron magnets or strontium ferrite or other magnetic alloys. When the fluid with suspended solids passes through this powerful magnetic field, its molecules are instantly polarized, making it less prone to adhesion on the internal faces of the pipelines. This descaling action remains effective for the entire length of the pipe.

The action of the magnetic field reduces the viscosity of the fluid being pumped, an advantage that promotes greater flow and productivity. Less fouling provides better performance of the installation with a longer interval between maintenance due to fouling and a reduction in the product flow area.

In an embodiment, a device for reducing viscosity and dissolving incrustations in pipelines comprising a central tube, the central tube comprising two ends and one or more external threads at the two ends of the central tube for coupling, a conical reduction, a protective jacket, and one or more spacer rings. The central tube is fixed to an orifice of the conical reduction by one or more weld fillits, The conical reduction comprising one or more permanent magnet collars. The one or more permanent magnet collars is made of neodymium boron iron or strontium ferrite and the one or more permanent magnet collars are internal to the protective jacket. The protective jacket is fixed to the conical reduction via a hole fully penetrating the one or more weld fillits. The one or more spacer rings made of non-magnetic metal, without a megnetic field which dress the central tube, are positioned juxtaposed to the one or more permanent magnet collars so that the ends of the one or more spacer rings are fixed to the central tube to preserve the location of the one or more spacer rings.

### DETAILED DESCRIPTION

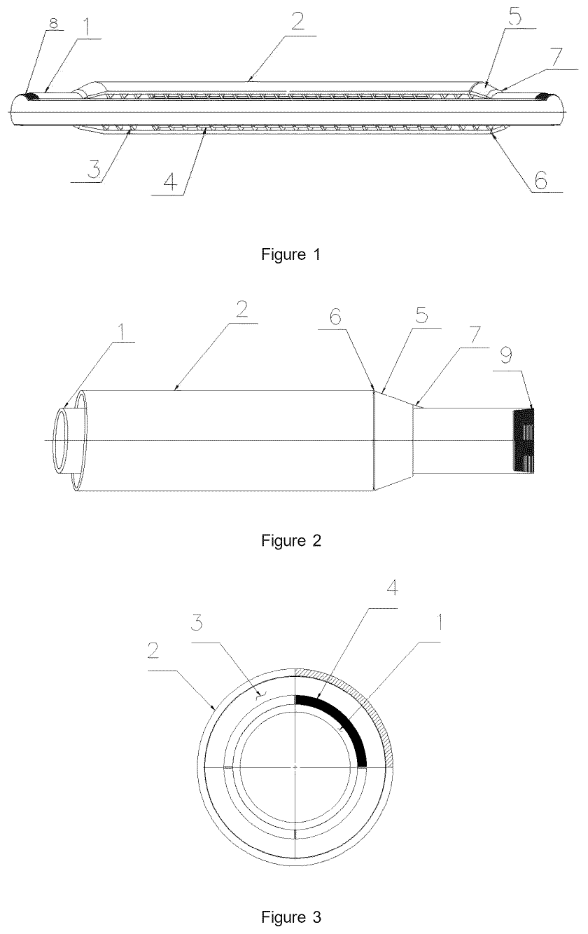

FIG. 1 shows the device in cross-section, allowing a view of the location of the components in the assembly. The central pipe (1) is the continuity of the original pipe. The protective jacket (2) of the magnet collars (4). the spacer rings (3) in non-magnetic metal are one-piece wearing the central tube (1), juxtaposed to the magnets, the ends of which are fixed to the central tube and thus preserve the location. The transition between the protective sleeve (2) and the central tube (1) is made with a conical reduction (5). The construction of the device block applies circumferential welded connections to the conical transitions near the ends. The device is installed in the extraction pipe by means of threads, which can be external threads (8) with or without a connecting sleeve or with a female thread at the other end. The circumferential weld beads (6) with the jacket and weld beads (7) with the central pipe are made with full penetration, with good technique and tested to ensure continuity.

FIG. 2 shows a partial external view of the device. The internal thread (9), a conical type in the moulds used in oil rigs, has a standardized geometry, arriving on the outer face with a larger diameter, attenuating the loss of resistance with the fillet recess. You can see the circumferential weld fillets (6) and (7). The protective sleeve (2) is centralized with the central tube (1).

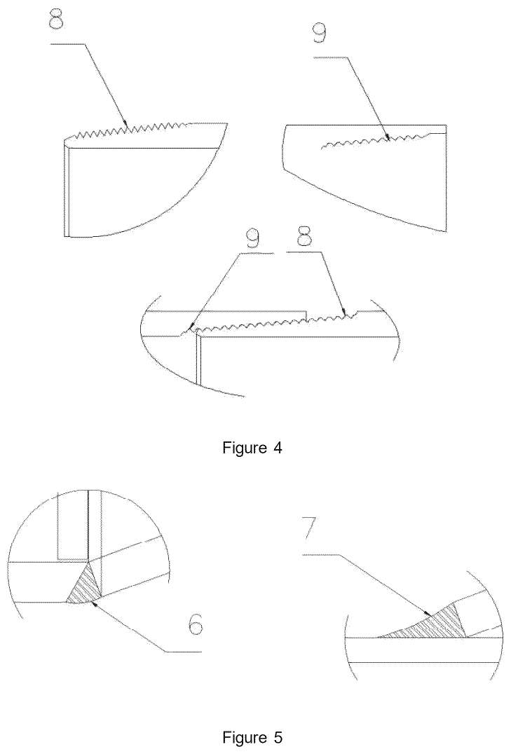

FIG. 3 shows the cross-section. You can see the magnet collars (4) in four segments of the same arc, the spacer rings (3), the central tube (1) and the protective sleeve (2).

FIG. 4 shows construction alternatives with an external thread (8) at both ends and a construction alternative with an internal thread (9) at one end so that it can be directly coupled to a male-female system without a threaded union sleeve. There is also a flanged alternative.

FIG. 5 shows in detail the fillet welds (6) and (7) joining the conical reduction (5), at both ends, with the sleeve (2) and the central tube (1). Weld beads with full penetration, the chamfers obtain geometry on the individual parts before assembly. The connection with the center tube (1) has a bulge to attenuate stress concentration at this transition.

The optimum conditions for the magnetic activation of oils and other fluids, for the present utility model, are those that cause the fluids, and in particular petroleum and its derivatives, to show the greatest reduction in their viscosities, and the least deposition of organic and inorganic materials in the pipes.

The inventors identified the variables of the fluid to be magnetically activated and established the set of variables specific to magnetic activators. The fluid variables are type, temperature, original viscosity, flow rate, electrical conductivity, pH, pressure and chemical composition. The variables of the magnetic activator are temperature, pressure, fluid speed, Reynolds number, desired final viscosity, magnetic field strength, type of magnet, length of the magnetically active zone and the time the fluid is exposed to the field.

Taking all these variables into account, the inventors designed and built magnetic activators that meet the optimum magnetic activation conditions for oils, whether crude or refined, as well as for other fluids, in accordance with customer requirements and the type of use, such as offshore or onshore wells, or in auxiliary systems such as heat exchangers and others. Optimum magnetic activation conditions are those that lead to the greatest reduction in viscosity and the greatest reduction in organic and inorganic deposition.

1. -3. (Canceled)

4. A device for reducing viscosity and dissolving incrustations in pipelines, comprising:
a central tube, the central tube comprising two ends and one or more external threads at the two ends of the central tube for coupling;
a conical reduction;
a protective jacket; and
one or more spacer rings, wherein
the central tube is fixed to an orifice of the conical reduction by one or more weld fillits,
the conical reduction comprising one or more permanent magnet collars, the one or more permanent magnet collars is made of neodymium boron iron or strontium ferrite and the one or more permanent magnet collars are internal to the protective jacket, the protective jacket is fixed to the conical reduction via a hole fully penetrating the one or more weld fillits, and
the one or more spacer rings made of non-magnetic metal, without a megnetic field which dress the central tube, are positioned juxtaposed to the one or more permanent magnet collars so that the ends of the one or more spacer rings are fixed to the central tube to preserve the location of the one or more spacer rings.

5. The device of claim 1, further comprises one or more internal threads at one of the two ends of the central tube.

6. The device of claim 1, further comprises an optimized shape to enable the device to be inserted into one or more fluid conduction lines inside underground wells, onshore and offshore oil and gas extraction platforms.
